(19) United States
(12) Patent Application Publication
(10) Pub. No.: US 2025/0223004 A1
(43) Pub. Date: Jul. 10, 2025

(54) DRIVE DEVICE FOR AN ELECTRIC BICYCLE, ELECTRIC BICYCLE, METHOD FOR ASSEMBLING A DRIVE DEVICE AND METHOD FOR ADJUSTING A DRIVE DEVICE

(71) Applicant: Porsche eBike Performance GmbH, Ottobrunn (DE)

(72) Inventor: Stephan Happ, Munich (DE)

(21) Appl. No.: 18/880,530

(22) PCT Filed: Jun. 6, 2023
(86) PCT No.: PCT/EP2023/065132

§ 371 Date: Dec. 31, 2024

(30) Foreign Application Priority Data
Jul. 6, 2022 (DE) 10 2022 116 834.4

(51) Int. Cl. B62M 6/55; B62M 11/02; B62M 17/00

(52) U.S. Cl. CPC B62M 6/55; B62M 11/02; B62M 17/00

(57) ABSTRACT

A drive device for an electric bicycle has a first housing element and a second housing element connected thereto. The device has a spacer element, a shaft and a redirecting gearbox for coupling with an electric motor and the shaft so that a torque can be transmitted from the motor to the shaft via the redirecting gearbox. The redirecting gearbox has a first gear element rotatable about a first axis and a second gear element coupled thereto, which is rotatable about a second axis extending at an angle to the first axis. The spacer element is arranged between two mutually facing housing surfaces of the two housing elements in order to define a minimum distance between the two housing surfaces. The gear elements are coupled to the housing elements such that a maximum clearance between the two gear elements is set by the defined minimum distance between the housing surfaces.

### CROSS-REFERENCE TO RELATED APPLICATIONS

This application is a continuation application of international patent application PCT/EP2023/065132, filed Jun. 6, 2023, designating the United States and claiming priority from German application 10 2022 116 834.4, filed Jul. 6, 2022, and the entire content of both applications is incorporated herein by reference.

### TECHNICAL FIELD

A drive device for an electric bicycle, an electric bicycle, a method for assembling a drive device, and a method for adjusting a drive device are disclosed.

### BACKGROUND

Bicycles are a cost-effective, easy-to-use and emission-free means of transportation. They have also become popular as sports and fitness equipment, and particularly suitable types have emerged for various sports applications.

In recent years, enthusiasm for electric bicycles (especially so-called “pedelecs”) has been growing, despite the high weights and prices for bicycles. With electric bicycles, it is a concern to provide a reliably supportive drive system that enables high power transmission. It is also important to provide a drive system that is simple to assemble and easy to adjust.

### SUMMARY

One task to be solved is to provide a reliable drive device for an electric bicycle, in particular a drive device with easily and precisely adjustable clearance between components of the drive device. Further tasks to be solved are to provide an electric bicycle with such a drive device, a method for assembling such a drive device and a method for adjusting such a drive device. These tasks are solved, inter alia, by various embodiments of the disclosure.

First, the drive device for an electric bicycle is specified.

In at least one embodiment, the drive device for an electric bicycle has a first housing element and a second housing element connected thereto for a housing of the drive device. The drive device further includes a spacer element and a shaft. In addition, the drive device has a redirecting gearbox for coupling with an electric motor on the one hand and with the shaft on the other hand so that a torque can be transmitted from the electric motor to the shaft via the redirecting gearbox. The redirecting gearbox has a first gear element that can rotate about a first axis and a second gear element coupled to it. The second gear element can be rotated about a second axis running at an angle to the first axis. The spacer element is arranged between two housing surfaces of the two housing elements facing each other to define a minimum distance between the two housing surfaces. The gear elements are coupled to the housing elements in such a way that a maximum clearance between the two gear elements is set by the defined minimum distance between the housing surfaces.

Setting the clearance between the gear elements of a redirecting gearbox is usually a complex process. The redirecting gearbox usually has to be assembled first in order to measure the clearance. If it turns out that a spacer element installed in the redirecting gearbox, for example a shim, has the wrong thickness, the redirecting gearbox must be disassembled again.

In the present disclosure, a spacer element is used between two housing surfaces of housing elements. Such a spacer element is much more easily accessible and can be replaced much more easily than a spacer element inside the redirecting gearbox.

The drive device can include a housing, which is at least partially formed by the first housing element and the second housing element. The redirecting gearbox is arranged inside the housing, for example. The shaft can be partially arranged inside the housing and a section of the shaft can protrude from the housing. The housing surfaces are preferably outer surfaces of the housing elements that are accessible from outside the housing. The housing elements are each formed in one piece, for example.

The two housing elements can be connected to each other directly or indirectly. For example, the two housing elements are connected to each other in a force-fit and/or form-fit and/or material-fit manner.

For example, the shaft is rotatably mounted about an axis parallel to the first axis, in particular about the first axis.

The redirecting gearbox, also known as an angular gearbox, is configured in particular to be coupled to the electric motor on the drive side and to the shaft on the output side. For example, the second gear element is configured for (direct) coupling with the electric motor. The first gear element is configured for coupling with the shaft, for example. For example, the first gear element is coupled to the shaft via a freewheel coupling. In particular, a freewheel clutch of the drive device can therefore be provided between the first gear element and the shaft, or the first gear element and/or the shaft can be part of such a freewheel clutch.

The redirecting gearbox can be a ratio-free redirecting gearbox, that is, the output speed of the redirecting gearbox is equal to the input speed. Alternatively, the redirecting gearbox can have a transmission ratio, for example of at least a factor of 2, so that the output speed is not equal to the input speed.

The first and second gear elements of the redirecting gearbox are coupled to each other, in particular in such a way that a torque can be transmitted from the second gear element to the first gear element and/or vice versa. For example, the coupling is such that each rotation of the second gear element about the second axis leads to a rotation of the first gear element about the first axis and/or vice versa. In particular, the gear elements are directly coupled to each other. The coupling between the first and second gear elements is realized, for example, by a toothed interface between the first and second gear elements. For example, the first and second gear elements engage directly with each other.

An interface of a coupling is understood here in particular to be the area in which a force or torque is transmitted between two elements, such as the gear elements. This area includes in particular the contact points between two components that can move relative to each other and/or the intermediate area between the components that can move relative to each other.

The second axis, about which the second gear element can be rotated, runs at an angle to the first axis, about which the first gear element can be rotated. For example, the second axis intersects the first axis at one point or is skew to the first axis. The first axis and the second axis can run perpendicular to each other or at an angle of less than 90° to each other. For example, an angle between the first axis and the second axis is at least 30° or at least 45°. The fact that a gear element is rotatable means here in particular that it can be rotated relative to the housing or the housing element.

The spacer element is arranged between two housing surfaces of the two housing elements that face each other. In the following, the housing surface of the first housing element is also referred to as the first housing surface, while the housing surface of the second housing element is also referred to as the second housing surface. The first housing surface is formed, for example, on a collar of the first housing element. The two housing surfaces can lie axially opposite each other in relation to the first axis and overlap radially and azimuthally with each other.

An axial direction in relation to an axis means here and hereinafter a direction along the axis. An azimuthal direction in relation to an axis means here and hereinafter a direction along a circular line around this axis and a radial direction in relation to an axis means here and hereinafter a direction perpendicular to the azimuthal direction and to the axial direction. The terms axial, azimuthal and radial are to be understood accordingly.

The fact that two elements overlap in one direction means that the coordinates of the two elements have an overlapping value range for this direction. In other words, the elements are then aligned with each other in this direction.

The spacer element can be in direct contact with the first and/or second housing surface. In particular, the minimum distance, that is, the smallest possible distance between the two housing surfaces, can be defined by the thickness of the spacer element or can correspond to this thickness. For example, the minimum distance is 0.6 mm to 1.0 mm. The thickness of the spacer element can also be selected in this range accordingly.

The gear elements are coupled to the housing elements in such a way that a maximum clearance between the two gear elements is set by the defined minimum distance between the housing surfaces. For example, the first gear element is coupled to the first housing element and the second gear element is coupled to the second housing element. At least one of the gear elements, for example the first gear element, can be axially movable relative to the associated housing element, that is, movable along the axis about which the gear element can be rotated. However, the axial mobility of the gear element is limited by the coupling to the associated housing element in such a way that the minimum distance mentioned above also ensures a maximum axial clearance between the gear elements.

The clearance between the two gear elements is therefore an axial clearance, for example. However, the axial clearance correlates to the torsional backlash. Torsional backlash refers to the torsional angle of the first gear element when the second gear element is locked.

According to at least one embodiment, the first housing element radially surrounds the first gear element and/or the shaft in relation to the first axis. For example, the first gear element and/or the shaft are completely surrounded radially by the first housing element. In other words, the first housing element extends once completely around the first gear element and/or the shaft in the azimuthal direction.

According to at least one embodiment, the second housing element radially surrounds the second gear element in relation to the second axis, for example radially completely.

According to at least one embodiment, the second gear element is arranged downstream of the first gear element in a first axial direction, parallel to the first axis. The first gear element can be axially movable within predetermined limits, parallel to the first axis, relative to the second gear element and/or to the first housing element and/or to the shaft.

According to at least one embodiment, the housing surface of the second housing element is arranged downstream of the housing surface of the first housing element in the first axial direction. In particular, the housing surface of the first housing element can face in the first axial direction and the housing surface of the second housing element can face in a second axial direction, antiparallel to the first axial direction.

For example, the second gear element is arranged downstream of the two housing surfaces in the first axial direction. In relation to the first axis, the two housing surfaces can be arranged axially overlapping with the first gear element. In relation to the first axis, the two housing surfaces are arranged, for example, radially offset to the first gear element, for example arranged radially further outwards than the first gear element.

According to at least one embodiment, the first gear element and the first housing element are assigned to a first assembly. In addition, the shaft can be assigned to the first assembly. For example, all elements of an assembly are coupled and/or connected to one another.

According to at least one embodiment, the second housing element and the second gear element are assigned to a second assembly.

According to at least one embodiment, the two assemblies are releasably connected to each other, in particular non-destructively releasably connected. For example, the two assemblies are connected to each other in such a way that, in order to release the connection, the first assembly is moved in a second axial direction, parallel to the first axis, away from the second assembly. The connection between the two assemblies is established, for example, completely or partially by the connection between the two housing elements. Accordingly, the connection between the housing elements can be releasable.

According to at least one embodiment, the two housing elements are connected to each other via a screw connection. To release the connection between the two housing elements, for example, the first housing element is moved relative to the second housing element both in the second axial direction and is rotated about the first axis. To establish the connection, the first housing element is moved relative to the second housing element in the first axial direction and is rotated about the first axis, for example.

According to at least one embodiment, the first and second housing elements each have a thread, with the two threads for the screw connection engaging with one another. For example, the second housing element has an internal thread and the first housing element has an external thread or vice versa. For example, to establish the connection between the housing elements, the first housing element or the first assembly is screwed into the second housing element or the second assembly.

According to at least one embodiment, the first housing element has at least one projection projecting radially outwards in relation to the first axis. The first housing surface is formed on the projection, for example.

The first housing element can have several such protrusions, whereby a first housing surface is then formed on each of these protrusions, for example. The projections are arranged, for example, equidistantly in the azimuthal direction in relation to the first axis and/or are evenly distributed around the first axis.

By way of example, the at least one projection is arranged in the first axial direction in front of the first gear element and/or in front of the second housing element. For example, the projection is formed at the end of the first housing element when viewed in the second axial direction.

According to at least one embodiment, the spacer element is ring-shaped or ring-segment-shaped. For example, the spacer element extends in relation to the first axis in the azimuthal direction partially or completely around the first axis. In particular, the spacer element can be an adjusting shim.

According to at least one embodiment, the spacer element is freely accessible from outside the housing elements, in particular from outside the housing. For example, the spacer element is exposed in the radial direction in relation to the first axis, that is, it is not surrounded by the housing in the radial direction.

According to at least one embodiment, the drive device is configured such that the spacer element can be separated from the housing elements, in particular from the housing, without completely releasing the connection between the housing elements. This makes it possible to replace the spacer element.

According to at least one embodiment, the spacer element is arranged moveably with respect to the housing elements between two positions. For example, the spacer element is arranged rotatably with respect to the two housing elements about the first axis.

According to at least one embodiment, in a first position a first section of the spacer element is arranged between the housing surfaces in order to define the minimum distance between the two housing surfaces. For example, the thickness of the first section of the spacer element defines the minimum distance between the housing surfaces.

According to at least one embodiment, in a second position the first section lies outside the area between the housing surfaces. The minimum distance between the housing surfaces is then independent of the spacer element, for example. For example, the distance between the two housing surfaces can then be set smaller than the minimum distance. The housing surfaces can, for example, be brought into contact with each other.

According to at least one embodiment, in the second position the spacer element can be separated from the housing elements, for example by axial displacement relative to the housing element, in particular in the second axial direction. For example, in the second position, the spacer element can be pulled off in the axial direction without any additional movement of the spacer element in another direction.

According to at least one embodiment, the spacer element is rotatable about the first axis and can be moved back and forth between the two positions by rotation. To move between the two positions, the spacer element must be rotated by an angle of at least 10° and/or at most 90°, for example.

According to at least one embodiment, the spacer element has a second section. For example, the second section is arranged downstream of the first section in the azimuthal direction in relation to the first axis or is arranged azimuthally next to the first section.

According to at least one embodiment, the first section is radially wider than the second section in relation to the first axis. In other words, the extent of the first section in the radial direction is greater than the extent of the second section in the radial direction. For example, the first section is radially at least twice as wide as the first section.

According to at least one embodiment, in the first position, the first section is, in relation to the first axis, arranged axially between the two housing surfaces and radially and azimuthally overlapping with the two housing surfaces. This means that the first section overlaps with the two housing surfaces in the azimuthal and radial directions and lies between the two housing surfaces in the axial direction. As a result, the minimum distance between the two housing surfaces is defined, for example, by the thickness of the spacer element.

According to at least one embodiment, in the second position, the second section is, in relation to the first axis, arranged axially between the two housing surfaces, azimuthally overlapping with the two housing surfaces and radially outside the area between the housing surfaces. This means that in the radial direction, the second section does not overlap with the area between the housing surfaces.

According to at least one embodiment, in the second position, the spacer element can be separated from the housing elements by axial displacement relative to the housing elements, in particular in the second axial direction. For example, the spacer element can then be pulled off over the first housing element.

Due to the configuration of the spacer element with a first and second section and the corresponding shape of the housing elements, the spacer element can be fixed and released between the housing surfaces of the housing elements like with a bayonet lock.

The spacer element can have several first sections and second sections, which are arranged alternately in the azimuthal direction (in relation to the first axis), for example.

According to at least one embodiment, the redirecting gearbox is a bevel gearbox. The first gear element is then, for example, a ring gear and the second gear element is a bevel pinion.

According to at least one embodiment, the shaft is a pedal crankshaft, that is, a shaft on which a pedal crank is mounted or can be mounted.

Next, the electric bicycle is specified. The electric bicycle is, for example, a so-called pedelec.

In at least one embodiment, the electric bicycle includes a drive device according to one of the embodiments described herein. Furthermore, the electric bicycle includes an electric motor, wherein the electric motor is coupled to the redirecting gearbox so that a torque of the electric motor is transmitted to the first gear element via the second gear element. Furthermore, the electric bicycle can have control electronics to control the electric motor.

Next, the method for assembling a drive device is provided. The method is particularly suitable for assembling a drive device according to one of the embodiments described herein. All features disclosed in connection with the method for assembling are therefore also disclosed for the drive device and vice versa.

In at least one embodiment of the method for assembling a drive device, a first assembly is provided including a first gear element for a redirecting gearbox and a first housing element for a housing. Further, a second assembly is provided including a second gear element for the redirecting gearbox and a second housing element for the housing. The two assemblies are connected, with the two housing elements being connected together. In addition, the two gear elements are coupled together for torque transmission. Furthermore, a spacer element is arranged between two housing surfaces of the two housing elements in order to define a minimum distance between the two housing surfaces. The gear elements are each coupled to the housing element of the associated assembly in such a way that a maximum clearance between the gear elements is set by the specified minimum distance.

When connecting the two assemblies, the housing elements are connected to each other in a form-fit and/or force-fit and/or material-fit manner, for example. For example, the housing elements are screwed into each other. The two gear elements can be coupled at the same time as the assemblies or the housing elements are connected or afterwards.

According to at least one embodiment, after the two housing elements or assemblies have been connected, the first gear element can be rotated about a first axis and the second gear element can be rotated about a second axis extending at an angle to the first axis. The first assembly can also include a shaft which can be rotated after the assemblies have been connected, in particular rotated about the first axis.

According to at least one embodiment, when the two assemblies are connected, the first assembly is moved towards the second assembly in an axial direction parallel to the first axis.

According to at least one embodiment, the spacer element is arranged axially between the housing surfaces in relation to the first axis. The two housing surfaces are then each brought into contact with the spacer element, for example.

Next, the method for adjusting a drive device is specified. The method can be used, for example, to adjust a drive device according to one of the embodiments described herein. All features disclosed in connection with the drive device are therefore also disclosed for the method and vice versa.

In at least one embodiment, the method includes checking whether the maximum clearance between the gear elements set by the spacer element meets specified requirements. If this is not the case, the spacer element is replaced by another spacer element, via which a different minimum distance between the two housing surfaces is defined and a different maximum clearance between the gear elements is set accordingly.

The specified requirements include, for example, smooth running of the transmission gearbox and/or noise that is generated when the transmission gearbox is operated.

The other spacer element can have a different thickness than the previously used spacer element. Apart from the thickness, the spacer elements can be identical.

According to at least one embodiment, a drive device is used in the method for adjusting the drive device, in which the spacer element is freely accessible from outside the housing elements and can be separated from the housing elements without completely releasing the connection between the housing elements. To replace the spacer element, the connection between the two housing elements is then preferably not completely released, for example only partially released or loosened. This means that the two housing elements remain connected to each other when the spacer element is replaced.

### BRIEF DESCRIPTION OF DRAWINGS

The invention will now be described with reference to the drawings wherein:

FIG. 1 shows an embodiment of an electric bicycle;

FIG. 2 shows a cross-sectional view of an embodiment of the drive device;

FIG. 3 shows an enlarged section of the embodiment of FIG. 2;

FIG. 4 shows an embodiment of the drive device in a perspective view from the outside;

FIG. 5 shows a plan view of an embodiment of a first housing element;

FIG. 6 shows a plan view of an embodiment of a spacer element;

FIGS. 7 and 8 show different positions in an embodiment of the drive device during the separation of the spacer element;

FIGS. 9 and 10 show different positions in an embodiment of the method for assembling a drive device; and,

FIG. 11 shows position in an embodiment of the method for adjusting a drive device.

### DETAILED DESCRIPTION

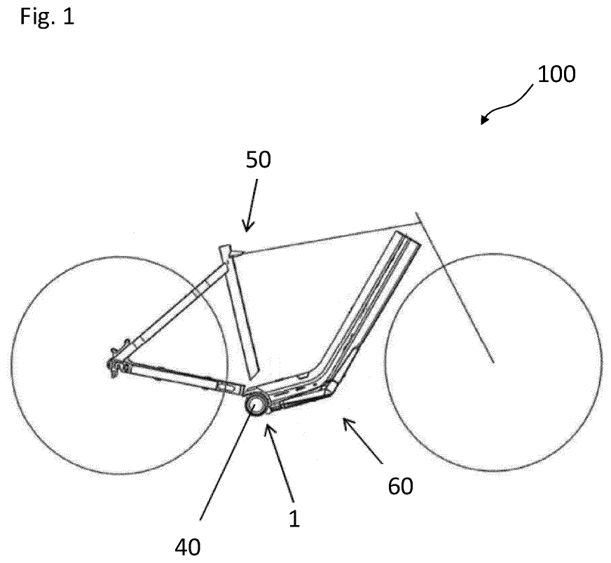

FIG. 1 schematically shows an electric bicycle 100 with a bicycle frame 50, which, among other things, has a lower frame section 60, which forms a down tube. The frame section 60 extends in the direction of a bottom bracket, which includes a pedal crank 40, which is coupled or couplable to a drive device 1 for the electric bicycle 100. The drive device 1 is coupled or couplable to an electric motor. The electric motor is arranged here, for example, in the seat tube of the frame 50.

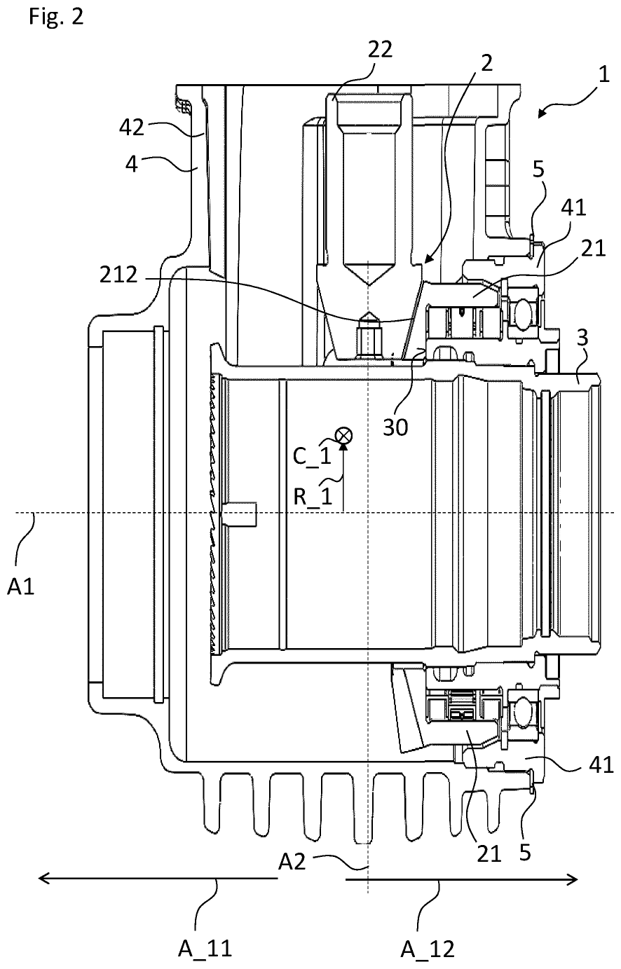

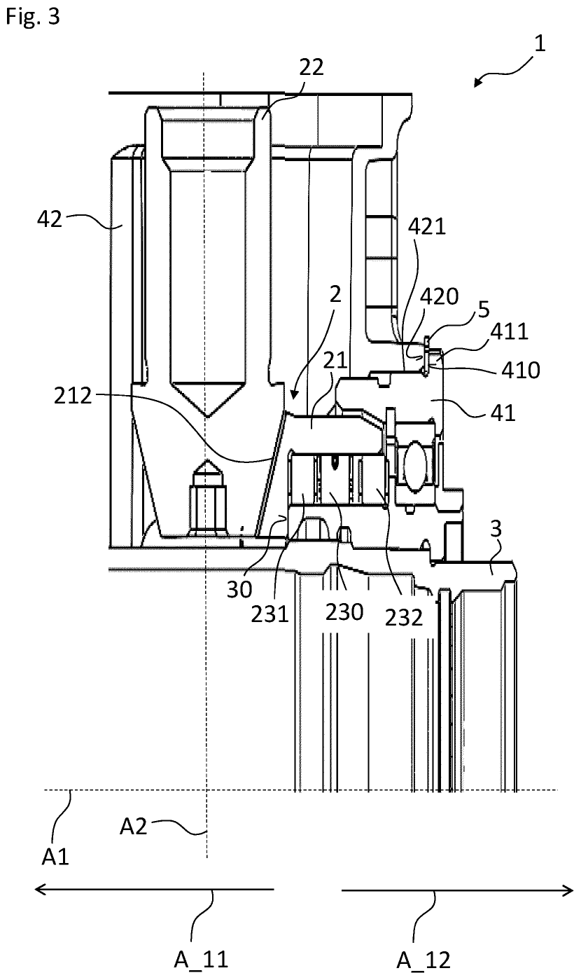

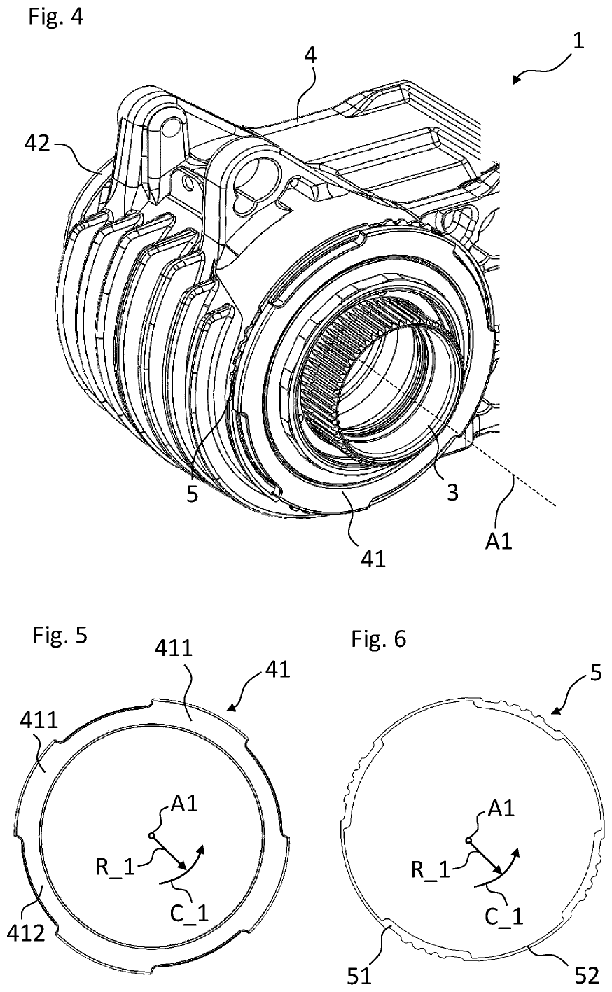

FIG. 2 shows a cross-sectional view of an embodiment of the drive device 1. For example, this is the drive device 1 used in the electric bicycle 100 of FIG. 1. FIG. 3 shows an enlarged section of FIG. 2. FIG. 4 shows a view of this drive device 1 from the outside.

The drive device 1 includes a housing 4 with two housing elements 41, 42. The housing 4 is made of plastic or aluminum, for example. A redirecting gearbox 2 is arranged inside the housing 4. The redirecting gearbox 2 includes a first gear element 21 and a second gear element 22. In the present case, the redirecting gearbox 2 is a bevel gearbox. The first gear element 21 is a ring gear and the second gear element 22 is a bevel pinion.

FIG. 2 also shows axes A1 and A2. The ring gear 21 is rotatably mounted (relative to the housing 4) about the first axis A1, the bevel pinion 22 is rotatably mounted (relative to the housing 4) about the axis A2. The axes A1 and A2 are perpendicular to each other. FIG. 2 also shows a radial direction R_1 and an azimuthal direction C_1 in relation to the first axis A1. The radial direction R_1 is a direction perpendicular to the first axis A1 and through the first axis A1 and the azimuthal direction C_1 is a direction perpendicular to the first axis A1, perpendicular to the radial direction R_1 and around the axis A1. In the illustration in FIG. 2, the azimuthal direction C_1 points into the plane of the paper.

The ring gear 21 surrounds a shaft 3 of the drive device 1 in the radial direction R_1. The shaft 3 is also mounted so that it can rotate about the first axis A1. In the present case, the shaft 3 is a chainring shaft. The shaft 3 is guided out of the housing 4 and can be connected to a chainring (see also FIG. 4). Shaft 3 is a hollow shaft.

The drive device 1 of FIG. 2 is arranged such that the bevel pinion 22 can be coupled to an electric motor for the electric bicycle. A direction of rotation of the rotor of the electric motor can run parallel to the axis A2 and/or parallel to the longitudinal axis of the saddle tube.

The bevel pinion 22 is driven by the energy provided by the electric motor, namely it rotates about the second axis A2. The bevel pinion 22 is coupled to the ring gear 21 via an interface 212. The interface 212 is a toothing interface. Due to the coupling via the interface 212, the rotation of the bevel pinion 22 leads to a rotation of the ring gear 21 about the first axis A1.

A clutch 230 is provided between the ring gear 21 and the shaft 3 (see FIG. 3). In the present case, the clutch 230 is, for example, a freewheel clutch. However, another mechanical clutch or an eddy current clutch could also be used.

The freewheel clutch allows the shaft 3 to rotate in a first direction of rotation, for example clockwise or counterclockwise, relative to the ring gear 21. Conversely, the ring gear 21 cannot rotate relative to the shaft 3 in the first direction of rotation. The ring gear 21 can maximally rotate together with the shaft, that is, at the same speed as the shaft 3, in the first direction of rotation. In this case, a coupling between the ring gear 21 and the shaft 3, provided by the clutch 230, transmits a torque supporting the rotation from the ring gear 21 to the shaft.

In order to facilitate the rotation of the ring gear 21 relative to the shaft 3 and to absorb any forces that occur, the drive device 1 includes two bearings 231, 232 (see FIG. 3). The freewheel clutch 230 is arranged axially between the two bearings 231, 232 in relation to the first axis A1. The bearings 231, 232 are roller bearings, in particular cylindrical roller bearings, for example ball bearings.

In the drive device 1 of the embodiment shown in FIG. 2, the ring gear 21 is, in relation to the first axis A1, arranged axially moveably relative to the shaft 3 and to the bevel pinion 22 and relative to the housing 4, namely within predetermined limits. On the one hand, the axial movement of the ring gear 21 in a first axial direction A_11 towards the bevel pinion 22 is limited by abutment against the bevel pinion 22. In the opposite, second axial direction A_12, the movement of the ring gear 21 is limited by abutment against a stop surface 30. The stop surface 30 is part of an element 32 that is axially fixed to the shaft 3. However, the stop surface 30 could also be part of the shaft 3, that is, formed integrally or in one piece with the shaft 3.

There is a clearance between the bevel pinion 22 and the ring gear 21 in the area of the interface 212. The maximum clearance between the bevel pinion 22 and the ring gear 21 is determined by how far the ring gear 21 can move away from the bevel pinion 22 in the second axial direction A_12, which in turn is determined by the axial position of the stop surface 30. The stop surface 30 is in turn axially fixed relative to the first housing element 41. The bevel pinion 22 is fixed axially, in relation to the first axis A1, to the second housing element 42. This means that, overall, the maximum clearance between the bevel pinion 22 and the ring gear 21 in the region of the interface 212 is determined by the positions of the housing elements 41, 42 along the first axis A1.

The axial positions of the housing elements 41, 42 in relation to the first axis A1 relative to each other are defined here by a spacer element 5, which is arranged between a first housing surface 410 of the first housing element 41 and a second housing surface 420 of the second housing element 42 (see FIG. 3). The housing surface 410 of the first housing element 41 is formed at a collar of the first housing element 41, in particular in the region of a projection 411 projecting radially outwards in relation to the first axis A1. The minimum distance between the two housing surfaces 410, 420 is defined by the thickness of the spacer element 5, measured along the first axis A1. The minimum distance between the housing surfaces 410, 420 defined by the spacer element 5 therefore ultimately sets the maximum clearance between the gear elements 21, 22 at the interface 212.

As can be clearly seen from FIGS. 2 and 3, the maximum clearance at the interface 212 can be adjusted by changing the thickness of the spacer element 5. A greater thickness of the spacer element 5 leads to a greater minimum distance between the two housing surfaces 410, 420 and thus to a greater maximum clearance, whereas a smaller thickness leads to a smaller minimum distance and correspondingly to a smaller maximum clearance.

As can be seen in FIGS. 2 and 3 and even more clearly in FIG. 4, the spacer element 5 is freely accessible from outside the housing 4. In the present case, the drive device 1 is arranged such that the spacer element 5 can be separated from the housing 4 without completely opening the housing 4, in particular without completely releasing the housing elements 41, 42 from each other. This is explained in more detail below with reference to FIGS. 5 to 8.

FIG. 5 shows a top view of the first housing element 41 of the drive device 1 of FIGS. 2 to 4, looking in the first axial direction A_11. The radial direction R_1 and azimuthal direction C_1 in relation to the first axis A1 are also shown. FIG. 5 shows that the first housing element 41 has a plurality of radially outwardly projecting projections 411. Sections 412 are arranged azimuthally between the projections 411. Measured in the radial direction R_1, the projections 411 have a greater width than the sections 412 and protrude further outwards in the radial direction than the sections 412. The first housing surface 410 is formed on the non-visible side of the projections 411.

FIG. 6 shows the spacer element 5 of the drive device 1 of FIGS. 2 to 4, also viewed along the first axis A1 and in the first axial direction A_11. The spacer element 5 includes a plurality of first sections 51 and a plurality of second sections 52, which are arranged alternately in the azimuthal direction C_1. The first sections 51 have a greater width measured in radial direction R_1 than the second sections 52 and protrude further radially inwards.

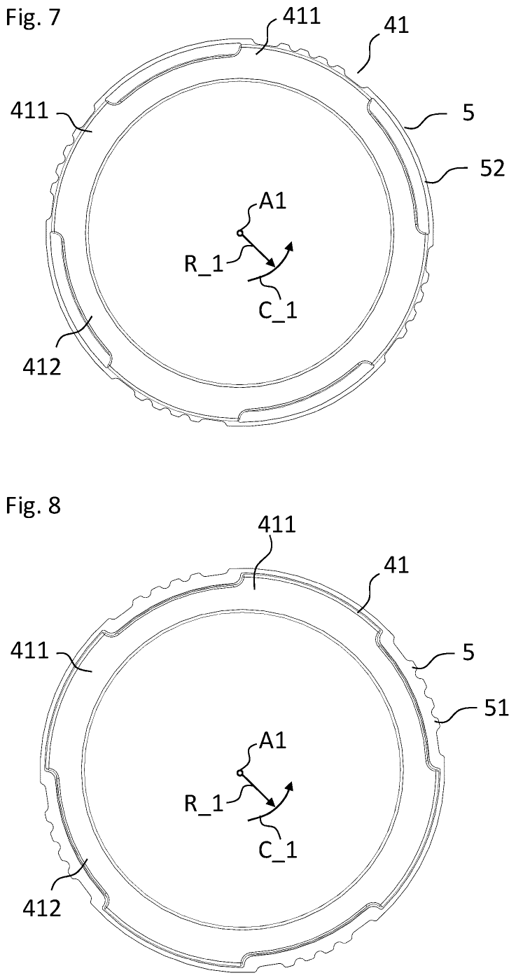

FIG. 7 shows an arrangement of the spacer element 5 relative to the first housing element 41 with the same viewing direction as in FIGS. 5 and 6. This arrangement corresponds to the arrangement in FIGS. 2 to 4, in which the minimum distance between the housing surfaces 410, 420 of the housing elements 41, 42 is defined by the spacer element 5. The first sections 51 of the spacer element 5 are arranged behind the projections 411 of the first housing element 41 so that the first sections 51 are arranged axially between the housing surfaces 410, 420 and radially and azimuthally overlapping with the housing surfaces 410, 420.

FIG. 8 shows an arrangement between the housing element 41 and the spacer element 5, in which the spacer element 5 does not define the minimum distance between the housing surfaces 410, 420 of the housing elements 41, 42, that is, the minimum distance is independent of the spacer element 5. Compared to the first position of the spacer element 5 shown in FIG. 7, in FIG. 8 the spacer element 5 is rotated relative to the first housing element 41 into a second position, namely about the first axis A1. As a result, the first sections 51 of the spacer element 5 have been brought out of the regions behind the projections 411 and now no longer overlap with the projections 411 in the azimuthal and radial directions. Instead, the first sections 51 overlap azimuthally with the sections 412 and, instead, the second sections 52 overlap azimuthally with the projections 411. However, since, in particular due to the smaller widths of the sections 412, the first sections 51 of the spacer element 5 now do not overlap radially with the sections 412 of the first housing element 41 and, furthermore, the second sections 52 of the spacer element 5 do not overlap radially with the projections 411 of the first housing element 41, among other things due to their smaller widths, in this second position the spacer element 5 can simply be pulled away from the housing 4 in the second axial direction A_12 over the first housing element 41.

Overall, locking the spacer element 5 to the housing 4 or separating the spacer element 5 from the housing 4 therefore functions in a similar way to a bayonet lock.

Since the spacer element 5 is preferably clamped in its first position for defining the minimum distance between the housing surfaces 410, 420, it may be necessary to slightly increase the distance between the housing surfaces 410, 420 in order to separate the spacer element 5. To make this possible, the connection between the housing elements 41, 42 is realized, for example, as a screw connection, with the first housing element 41 having an external thread and the second housing element 42 having an internal thread. The interface 421, at which the two threads engage with one another, is shown in FIG. 2. By slightly rotating the first housing element 41 relative to the second housing element 42, the first housing element 41 moves in the second axial direction A_12 relative to the second housing element 42, whereby the distance between the two housing surfaces 410, 420 is increased.

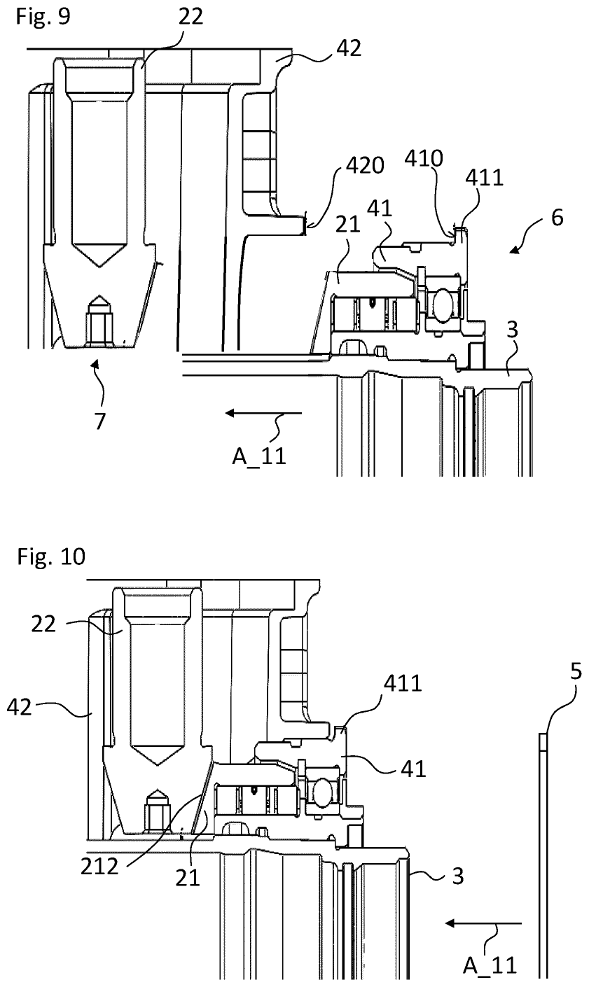

FIGS. 9 and 10 show, based on two positions, an embodiment of the method for assembling a drive device 1. In the present case, the drive device 1 of FIGS. 1 to 4 is assembled.

In the first position of FIG. 9, a first assembly 6 including the first housing element 41, the shaft 3 and the ring gear 21 is provided. These three elements of the first assembly are coupled to one another. In addition, a second assembly 7 including the bevel pinion 22 and the second housing element 22 is provided, which are also coupled to one another. In FIG. 9, the first assembly 6 is moved in the first axial direction A_11 towards the second assembly 7 and the two housing elements 41, 42 are connected to one another via the meshing of the threads. In addition, the gear elements 21, 22 are coupled together.

FIG. 10 shows a position in which the two assemblies 6, 7 are connected to each other to such an extent that a gap remains between the housing surfaces 410, 420 of the housing elements 41, 42. Now the spacer element 5 can be pushed in the first axial direction A_11 over the shaft 3 and the first housing element 41 and then locked by a rotation between the housing surfaces 410, 420, as described in connection with FIGS. 7 and 8. If the two housing elements 41, 42 are now brought even closer together by tightening the screw connection, this is only possible until both housing surfaces 410, 420 come into contact with the spacer element 5. The minimum distance between the housing surfaces 410, 420 is thus defined by the thickness of the spacer element 5 and the maximum clearance between the gear elements 21, 22 at the interface 212 is set accordingly.

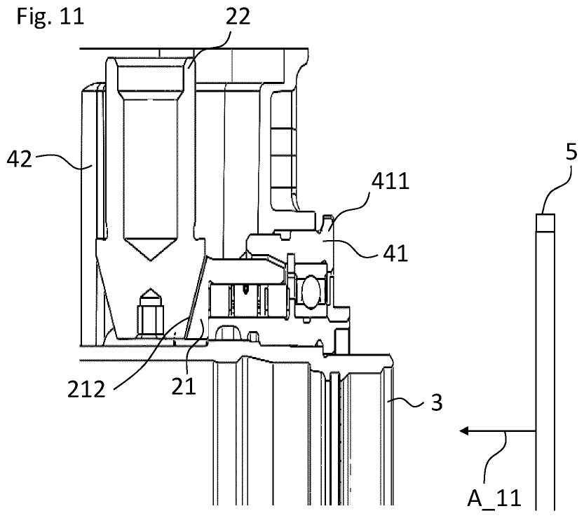

If it turns out that the set clearance at the interface 212 does not meet certain requirements for the drive device 1, the spacer element 5 can simply be replaced by a thicker or thinner spacer element 5 in order to set a larger or smaller minimum distance and correspondingly set a larger or smaller maximum clearance. This is shown as an example in FIG. 11, where a thicker spacer element 5 is used.

To replace the spacer element 5 of FIG. 10 with the thicker spacer element 5 of FIG. 11, the housing 4 including the first housing element 41 and the second housing element 42 does not have to be opened completely, because it is sufficient, for example, to slightly loosen the screw connection between the housing elements 41, 42, then rotate the spacer element 5 of FIG. 10 and then separate it from the housing elements 41, 42 (see FIGS. 7 and 8). The thicker spacer element 5 of FIG. 11 can then be pushed in the first axial direction A_11 over the shaft 3 and the first housing element 41 and secured by rotation between the housing surfaces 410, 420. By tightening the screw connection, the thicker spacer element 5 is then clamped between the housing surfaces 410, 420 and defines the new, larger minimum distance between the housing surfaces 410, 420.

It is understood that the foregoing description is that of the preferred embodiments of the invention and that various changes and modifications may be made thereto without departing from the spirit and scope of the invention as defined in the appended claims.

### LIST OF REFERENCE SIGNS

1 drive unit
2 redirecting gearbox
3 shaft
4 housing
5 spacer element
6 first assembly
7 second assembly
21 first gear element
22 second gear element
30 stop surface
32 element
40 pedal crank
41 first housing element
42 second housing element
50 bicycle frame
51 first section
52 second section
60 frame section
100 electric bicycle
212 interface
230 clutch
231 bearing
232 bearing
410 first housing surface
411 projection
412 section
420 second housing surface
421 interface
A1 first axis
A2 second axis
A_11 first axial direction
A_12 second axial direction
R_1 radial direction
C_1 azimuthal direction

1-16. (canceled)

17. A drive device for an electric bicycle, the drive device comprising:
a first housing element defining a first housing surface;
a second housing element defining a second housing surface and being connected to said first housing element for a housing of the drive device;
a spacer element;
a shaft;
a redirecting gearbox for coupling with an electric motor and said shaft so that a torque is transmittable from the electric motor via said redirecting gearbox to said shaft;
said redirecting gearbox having a first gear element rotatable about a first axis and a second gear element coupled to said first gear element, said second gear element being rotatable about a second axis running at an angle to the first axis;
wherein said first housing surface and said second housing surface face each other;
said spacer element being arranged between said first housing surface and said second housing surface to define a minimum distance between said first housing surface and said second housing surface; and,
said first gear element and said second gear element being coupled to said first housing element and said second housing element such that a maximum clearance between said first gear element and said second gear element is set by a defined minimum distance between said first housing surface and said second housing surface.

18. The drive device of claim 17, wherein:
said first housing element radially surrounds at least one of said first gear element and said shaft in relation to the first axis;
said second housing element radially surrounds said second gear element in relation to the second axis;
said second gear element is arranged downstream of said first gear element in a first axial direction, parallel to the first axis; and,
said second housing surface is arranged downstream of said first housing surface in the first axial direction.

19. The drive device of claim 17, wherein:
said first housing element and said first gear element are assigned to a first assembly;
said second housing element and said second gear element are assigned to a second assembly; and,
said first assembly and said second assembly are releasably connected to each other such that:
to release the connection, said first assembly is moved in a second axial direction, parallel to the first axis, away from said second assembly.

20. The drive device of claim 17, wherein:
said first housing element and said second housing element are connected to each other via a screw connection; and,
said first housing element and said second housing element each have a thread and the two threads for said screw connection engage with each other.

21. The drive device of claim 17, wherein said first housing element has at least one projection projecting radially outwards in relation to the first axis and said first housing surface is formed at said at least one projection.

22. The drive device of claim 17, wherein said spacer element is ring-shaped or ring-segment-shaped.

23. The drive device of claim 17, wherein:
said spacer element is freely accessible from outside said first housing element and said second housing element; and,
the drive device is configured such that said spacer element is separable from said first housing element and said second housing element without completely releasing a connection between said first housing element and said second housing element in order to enable said spacer element to be replaced.

24. The drive device of claim 17, wherein:
said spacer element is arranged moveably between two positions with respect to said first housing element and said second housing element;
in a first position, a first portion of said spacer element is arranged between said first housing surface and said second housing surface to define the minimum distance between said first housing surface and said second housing surface; and,
in a second position, said first portion is outside an area between said first housing surface and said second housing surface and the minimum distance between said first housing surface and said second housing surface is independent of said spacer element.

25. The drive device of claim 24, wherein, in said second position, said spacer element is separable from said first housing element and said second housing element.

26. The drive device of claim 25, wherein:
said spacer element is rotatable about the first axis and is configured to be moved back and forth between said first position and said second position by rotation;
said spacer element has a second section,
in said first position, said first section is, in relation to the first axis, arranged axially between said first housing surface and said second housing surface and radially and azimuthally overlapping with said first housing surface and said second housing surface;
in said second position, said second section lies axially between said first housing surface and said second housing surface with respect to the first axis, and azimuthally overlapping with said first housing surface and said second housing surface and radially outside the area between said first housing surface and said second housing surface; and,
said spacer element is separable from said first housing element and said second housing element by axial displacement.

27. The drive device of claim 17, wherein at least one of:
said redirecting gearbox is a bevel gearbox in which said first gear element is a ring gear and the second gear element is a bevel pinion; and,
said shaft is a chainring shaft.

28. An electric bicycle comprising:
an electric motor;
a drive device including a first housing element, a second housing element, a spacer element, a shaft, and a redirecting gearbox;
said first housing element defining a first housing surface;
said second housing element defining a second housing surface and being connected to said first housing element for a housing of the drive device;
said redirecting gearbox for coupling with said electric motor and said shaft so that a torque is transmittable from said electric motor via said redirecting gearbox to said shaft;
said redirecting gearbox having a first gear element rotatable about a first axis and a second gear element coupled to said first gear element, said second gear element being rotatable about a second axis running at an angle to the first axis;
wherein said first housing surface and said second housing surface face each other;
said spacer element being arranged between said first housing surface and said second housing surface to define a minimum distance between said first housing surface and said second housing surface; and,
said first gear element and said second gear element being coupled to said first housing element and said second housing element such that a maximum clearance between said first gear element and said second gear element is set by a defined minimum distance between said first housing surface and said second housing surface; and,
said electric motor being coupled to said redirecting gearbox so that the torque of said electric motor is transmitted to said first gear element via said second gear element.

29. A method for assembling a drive device, the method comprising:
providing a first assembly having a first gear element for a redirecting gearbox and a first housing element for a housing;
providing a second assembly having a second gear element for the redirecting gearbox and a second housing element for the housing;
connecting the two assemblies, wherein the first housing element and the second housing element are interconnected;
coupling the first gear element and the second gear element for torque transmission; and,
arranging a spacer element between two housing surfaces of the two housing elements in order to define a minimum distance between the two housing surfaces;
wherein the first gear element is coupled to the first housing element and the second gear element is coupled to the second housing element such that a maximum clearance between the first gear element and the second gear element is set by a defined minimum distance.

30. The method of claim 29, wherein:
after connecting the housing elements, the first gear element is rotatable about a first axis and the second gear element is rotatable about a second axis extending at an angle to the first axis; and,
when connecting the two assemblies:
the first assembly is moved towards the second assembly in an axial direction parallel to the first axis, and,
the spacer element is arranged axially between the housing surfaces in relation to the first axis.

31. A method for adjusting a drive device having a first housing element, a second housing element, a spacer element, a shaft, and a redirecting gearbox, the first housing element defining a first housing surface, the second housing element defining a second housing surface and being connected to the first housing element for a housing of the drive device, the redirecting gearbox being for coupling with an electric motor and the shaft so that a torque is transmittable from the electric motor via the redirecting gearbox to the shaft, the redirecting gearbox having a first gear element rotatable about a first axis and a second gear element coupled to the first gear element, the second gear element being rotatable about a second axis running at an angle to the first axis, wherein the first housing surface and the second housing surface face each other, the spacer element being arranged between the first housing surface and the second housing surface to define a minimum distance between the first housing surface and the second housing surface; and, the first gear element and the second gear element being coupled to the first housing element and the second housing element such that a maximum clearance between the first gear element and the second gear element is set by a defined minimum distance between the first housing surface and the second housing surface, the method comprising:
checking whether the maximum clearance between the first gear element and the second gear element set by the spacer element meets specified requirements and, if not, replacing the spacer element by another spacer element, via which a different minimum distance between the two housing surfaces is defined and a different maximum clearance between the first gear element and the second gear element is set accordingly.

32. The method of claim 31, wherein:
the spacer element is freely accessible from outside the first housing element and the second housing element;
the drive device is configured such that the spacer element is separable from the first housing element and the second housing element without completely releasing a connection between the first housing element and the second housing element in order to enable the spacer element to be replaced; and,
the connection between the first housing element and the second housing element is not released to replace the spacer element.
